(19) United States
(12) Patent Application Publication
(10) Pub. No.: US 2025/0130122 A1
(43) Pub. Date: Apr. 24, 2025

(54) APPARATUS FOR MEASURING FLUID TEMPERATURE

(71) Applicants: HYUNDAI MOTOR COMPANY, SEOUL (KR); KIA CORPORATION, SEOUL (KR)

(72) Inventors: Jeong Bin Park, Suwon-si (KR); Yang Bo Kang, Suwon-si (KR); Jeong Seon Min, Suwon-si (KR)

(73) Assignees: HYUNDAI MOTOR COMPANY, SEOUL (KR); KIA CORPORATION, SEOUL (KR)

(21) Appl. No.: 18/650,604

(22) Filed: Apr. 30, 2024

(30) Foreign Application Priority Data
Oct. 19, 2023 (KR) 10-2023-0140161

(51) Int. Cl. G01K 13/024; G01K 1/02; G01K 1/14

(52) U.S. Cl. CPC G01K 13/024; G01K 1/026; G01K 1/14

(57) ABSTRACT

A temperature measurement apparatus for moving fluids includes a base configured such that a fluid flowing in a flow direction passes through the base, and a plurality of temperature sensors disposed on the base or around the base. The plurality of temperature temperatures are configured to measure a plurality of temperatures of the fluid.

### CROSS REFERENCE TO RELATED APPLICATIONS

This application claims under 35 U.S.C. § 119(a) the benefit of priority to Korean Patent Application No. 10-2023-0140161, filed on Oct. 19, 2023, the entire contents of which are incorporated herein by reference.

### TECHNICAL FIELD

The present disclosure relates to an apparatus for measuring temperature of a moving fluid.

### BACKGROUND

An engine moves a piston in a cylinder using combustion pressure generated due to combustion of a fuel and oxygen in air. The combustion gas is discharged to air via an exhaust system including an exhaust valve, an exhaust manifold, a catalytic converter, an exhaust pipe, and the like. A gas temperature at each position of the exhaust system may be a very important factor directly related to performance of a machine including the engine.

For example, in a vehicle which is the machine including the engine, the temperature of the exhaust system is raised as an engine output increases due to improved performance thereof. Therefore, the vehicle should be developed so that the temperature of the exhaust system meets an allowable limit temperature to achieve the optimum performance of the engine. When the limit temperature is unnecessarily excessively reduced, performance loss as much as the amount of temperature reduction may be incurred.

However, when the temperature of the exhaust system is raised, a problem due to thermal damage may occur. Therefore, the engine controls temperature at all times through Component of Protection (COP) control so that the temperature of exhaust gas does not exceed the limit temperature.

As such, accurate temperature measurement of the exhaust system is required to control temperature. An optimum catalyst and exhaust system parts may be designed only when the temperature of the exhaust gas is accurately acquired. Because it is actually difficult to accurately measure the temperature of the exhaust gas and high development costs and production costs are required to accurately measure the temperature of the exhaust gas, the COP control is performed using temperature modeling without using temperature sensors.

Concretely, a sensor is installed at each critical point inside the exhaust system in a vehicle development stage. The sensors measure temperatures in various driving modes of the vehicle, and each of the temperature values measured by the sensors corresponds to a virtual modeled temperature.

However, in case that there is an error in the modeled temperature, the temperature of the exhaust system may exceed the limit temperature and may thus cause a problem in the vehicle.

In order to install the sensors in the exhaust system, exhaust system parts are removed, the exhaust pipe or the like in each position is perforated, and a thermocouple is installed therein. These operations cause loss of a man-hour. Further, when the route of the exhaust pipe is changed or factors influencing temperature are changed in the development stage, the above operations should be repeated. In addition, during the operations including perforation, it is difficult to install the sensor accurately at the central line of the exhaust pipe, and thus, an error is bound to occur. In case of a vehicle having high displacement, it may be difficult to remove exhaust system parts, so disassembly of an engine may be performed instead.

The above information disclosed in this Background section is only for enhancement of understanding of the background of the disclosure and therefore it may contain information that does not form the prior art that is already known to one having ordinary skill in the art.

### SUMMARY

The present disclosure has been made in an effort to solve the above-described problems associated with the prior art, and it is an object of the present disclosure to provide a temperature measurement apparatus for fluids which may accurately and effectively measure the temperature of exhaust gas.

In one aspect, the present disclosure provides a temperature measurement apparatus for fluids, including a base configured such that a fluid flowing in a flow direction passes therethrough, and a plurality of temperature sensors disposed on the base or around the base and configured to measure temperatures of the fluid.

In another aspect, the present disclosure provides a temperature measurement method for moving fluids by a temperature measurement apparatus including a base, a plurality of temperature sensors, and a temperature collector configured to collect and process temperatures measured by the plurality of temperature sensors, the temperature measurement method including comparing a first temperature of a fluid measured at an upstream area from the base and a second temperature of the fluid measured at a center of a fluid flow configured to pass through the base, comparing the second temperature and a third temperature of the fluid measured at a downstream area from of the base, comparing the second temperature and at least one fourth temperature of the fluid measured at a plurality of points of a perimeter of the fluid flow configured to pass through the base, and determining whether or not magnitudes of the first temperature, the second temperature, the third temperature and the at least one fourth temperature follow a predetermined order based on the comparisons.

Other aspects and preferred embodiments of the disclosure are discussed infra.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a schematic view of a temperature measurement apparatus for fluids according to one embodiment of the present disclosure;

FIGS. 2, 3, 4, and 5 are perspective views of the temperature measurement apparatus according to one embodiment of the present disclosure; and

FIG. 6 is a flowchart representing a method of measuring temperature by the temperature measurement apparatus according to one embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

Specific structural or functional descriptions in embodiments of the present disclosure set forth in the description which follows will be exemplarily given to describe the embodiments of the present disclosure, and the present disclosure may be embodied in many alternative forms. Further, it will be understood that the present disclosure should not be construed as being limited to the embodiments set forth herein, and the embodiments of the present disclosure are provided only to completely disclose the disclosure and cover modifications, equivalents or alternatives which come within the scope and technical range of the disclosure.

In the following description of the embodiments, terms, such as “first” and “second”, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” etc.

Wherever possible, the same reference numbers will be used throughout the drawings to refer to the same or like parts. The terminology used herein is for the purpose of describing particular embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, operations, operations, elements, components, and/or combinations thereof, but do not preclude the presence or addition of one or more other features, integers, operations, operations, elements, components, and/or combinations thereof.

Hereinafter reference will be made in detail to various embodiments of the present disclosure, examples of which are illustrated in the accompanying drawings and described below.

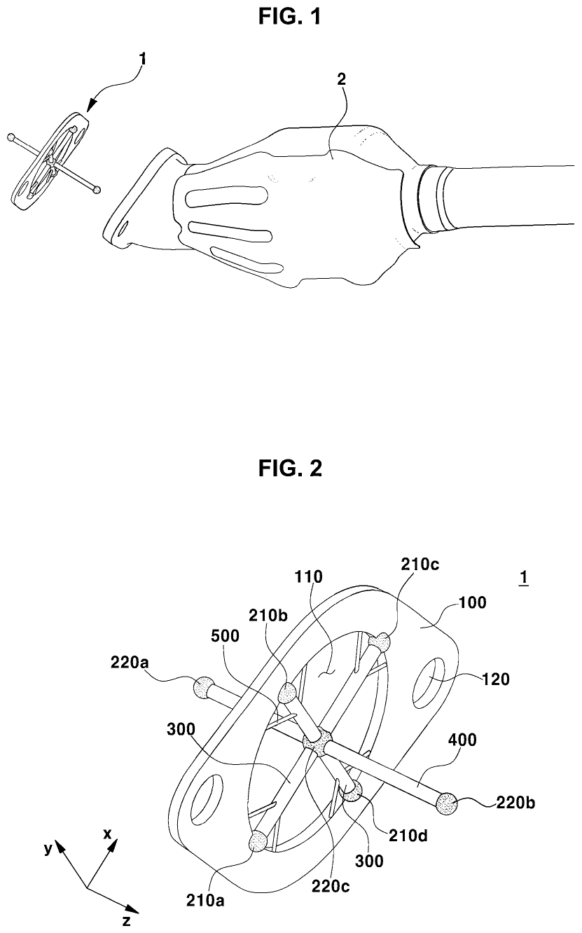

As shown in FIG. 1, a temperature measurement apparatus 1 for fluids according to the present disclosure may measure the temperature of a moving fluid. For example, the temperature measurement apparatus 1 may measure the temperature of a moving fluid which passes through one or more exhaust system components 2. In one example of implementation, the temperature measurement apparatus 1 may be disposed on the exhaust system components 2. For example, the temperature measurement apparatus 1 may include a gasket configured to maintain airtightness between exhaust system components 2.

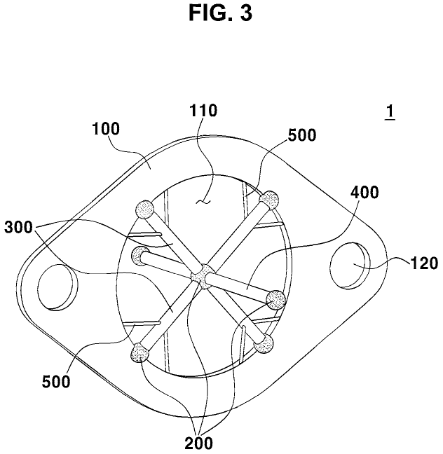

As shown in FIGS. 2 and 3, the temperature measurement apparatus 1 includes a base 100 and one or more temperature sensors 200. The base 100 may be disposed on a path through which the fluid or exhaust gas flows. In one example of implementation, the base 100 may be a gasket configured to maintain airtightness between the exhaust system parts 2.

The base 100 includes a hole 110. The fluid or the exhaust gas may pass through the hole 110. Otherwise, the base 100 may include two or more holes 120 coupled to the exhaust system parts 2.

The temperature sensors 200 may be disposed on the base 100. The temperature sensors 200 may be disposed in or around the hole 110 and may measure the temperature of the fluid passing through the hole 110. In one example of implementation, the temperature sensors 200 are thermocouples.

In one example of implementation, the temperature sensors 200 include a first group of temperature sensors 210a, 210b, 210c and 210d. The first group of the temperature sensors 210a, 210b, 210c and 210d may be disposed in the hole 110. In one example of implementation, the first group of the temperature sensors 210a, 210b, 210c and 210d may be disposed around the hole 110. For example, the first group of the temperature sensors 210a, 210b, 210c and 210d may be disposed around the hole 110 through one or more support rods 300. In one example of implementation, the temperature sensors 210a and 210c or the temperature sensors 210b and 210d may be disposed at both ends of each of the support rods 300, respectively. Each of the support rods 300 having the temperature sensors 210a and 210c or the temperature sensors 210b and 210d disposed thereon may be inserted into the hole 110 to be fixed thereto.

The temperature sensors 200 come into contact with the base 100 and are fixed thereto through insertion of the support rods 300 into the hole 110. In one example of implementation, at least one support rod 300 may be disposed in the hole 110. For example, each support rod 300 may be mounted in the hole 110 while intersecting with another support rod 300 in the center of the hole 110. Although the shown example of implementation illustrates two support rods 300, the number of the support rods 300 may be increased or decreased. In one example of implementation, the support rods 300 may be formed integrally with the temperature sensors 200, which are thermocouples, and may prevent the base 100, which is a thin gasket, from twisting.

In one example of implementation, the temperature sensors 200 include second group of temperature sensors 220a and 220b. The second group of the temperature sensors 220a and 220b may be disposed outside the hole 110 or at positions spaced apart from the hole 110. For example, the second group of the temperature sensors 220a and 220 may be disposed at positions spaced apart from the hole 110 through an extension rod 400. The extension rod 400 may extend in a direction approximately parallel to the flow direction of the fluid (the z-axis direction). The extension rod 400 may be connected to the support rods 300 and may be disposed in the hole 110. The second group of the temperature sensors 220a and 220b may be disposed at both ends of the extension rod 400. Among the second group of the temperature sensors 220a and 220b disposed at the respective end of the extension rod 400, one temperature sensor 220a in the second group of the temperature sensor may be disposed upstream in the flow direction of the fluid, and the other temperature sensor 220b in the second group of the temperature sensor may be disposed downstream in the flow direction of the fluid.

In one example of implementation, a third group temperature sensor 220c may be disposed in the center of the hole 110. For example, the third group temperature sensor 220c may be disposed at an intersection where the support rods 300 and the extension rod 400 meet one another. That is, the third group temperature sensor 220c may be disposed in the center of the hole 110.

Correctly measured temperature values are obtained only when temperatures measured by the first group of the temperature sensors 210a, 210b, 210c and 210d are higher than a temperature measured by the third group temperature sensor 220c. Therefore, according to the present disclosure, temperatures of the fluid at several certain points of a cross section of the path, through which the fluid flows, may be measured. Therefore, reliability in temperature measurement may be improved.

Further, the temperature measured by the temperature sensor 220a disposed upstream out of the second group of the temperature sensors 220a and 220b should be higher than the temperature measured by the third group temperature sensor 220c. The temperature measured by the third group temperature sensor 220c should be higher than the temperature sensor 220b disposed downstream out of the second group of the temperature sensors 220a and 220b. According to the present disclosure, whether the temperature measurement is correct may be easily determined from the temperature values measured by the second group of the temperature sensors 220a and 220b and the third group temperature sensor 220c. Accordingly, reliability in temperature measurement may be improved.

In some examples of implementation, the temperature sensors 200 may be additionally mounted at positions of the support rods 300 and the extension rod 400 other than the above-described positions. Further, additional first to third group of the temperature sensors 200 may be provided in the temperature measurement apparatus 1 so that the respective number of the first to third group of the temperature sensors 200 exceed the numbers shown in the figures.

In one example of implementation of the present disclosure, the temperature measurement apparatus 1 includes one or more reinforcement members 500. The reinforcement members 500 may firmly fix the support rods 300 or the extension rod 400 disposed in the hole 110. For example, as in the illustrated example, a pair of reinforcement members 500 may connect each of the support rods 300 to the base 100.

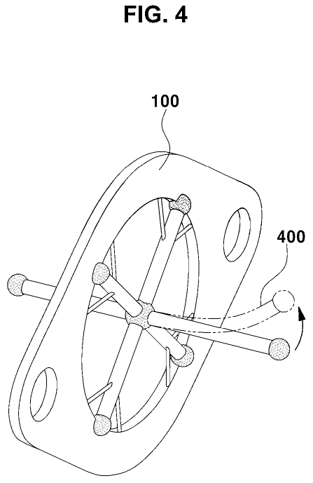

Referring to FIG. 4, in some examples of implementation of the present disclosure, the extension rod 400 may be formed of a soft material. For example, when the path of the exhaust system component 2, through which the fluid flows, is bent at a portion of the exhaust system component 2 joined to the base 100, the extension rod 400 may also be bent to be parallel to the bent path.

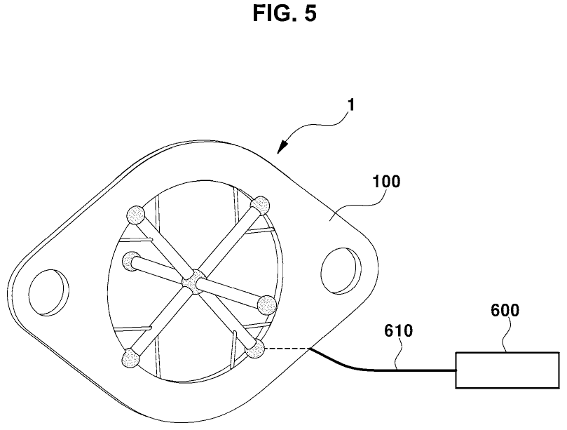

As shown in FIG. 5, the temperature measurement apparatus 1 according to the present disclosure includes a temperature collector 600. For example, the temperature collector 600 may include a processor and a memory and may process and store temperature information measured by the temperature sensors 200.

The temperature collector 600 may communicate with the temperature sensors 200. For example, the temperature controller 600 may communicate with the temperature sensors 200 by a wired or wireless method. In one example of implementation, the temperature collector 600 may be connected to the temperature sensors 200 by a wire 610. In one example of implementation, the wire 610 may be connected to the temperature sensors 200 via the base 200 and additionally via the support rods 300 or the extension rod 400. The wire 610 may be connected to the temperature sensors 200 by passing through the base 100 so that a stable structure may be ensured. In one example of implementation, the temperature collector 600 may include an interface. The temperature collector 600 may output the measured temperature values, an error count, and a warning message which will be described below and the like to a user through the interface.

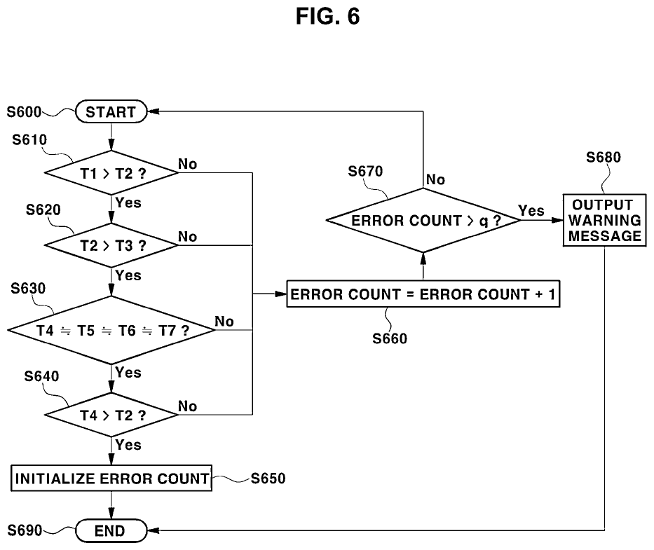

The temperature collector 600 may monitor the temperature of the fluid based on the measured temperatures. For example, the temperature collector 600 may perform a monitoring operation, as shown in FIG. 6. That is, the temperature collector 600 may easily determine whether temperature measurement is properly performed through comparison among the temperature values measured by the respective temperature sensors 200, which improves reliability in temperature measurement.

At operation S600, the temperature sensors 200 start measurement of temperatures of the fluid or exhaust gas in the exhaust system. The temperature collector 600 receives temperature information from the respective temperature sensor 200.

At operation 610, the temperature collector 600 compares a first temperature T1 measured by the temperature sensor 220a disposed upstream in the flow direction of the fluid out of the second group of the temperature sensors 220a and 220 with a second temperature T2 measured by the third group temperature sensor 220c disposed at the center of the temperature measurement apparatus 1. Concretely, the temperature collector 600 determines whether the first temperature T1 exceeds the second temperature T2. Upon determining that the first temperature T1 exceeds the second temperature T2, operation S620 is executed. Upon determining that the first temperature T1 is equal to lower than the second temperature T2, the temperature collector 600 determines this situation as an error, sets an error count to +1, and then stores the set error count at operation S660.

At operation S620, the temperature collector 600 compares the second temperature T1 and a third temperature T3 measured by the temperature sensor 220b disposed downstream in the flow direction of the fluid in the second group of the temperature sensor 220a, 220b. Concretely, the temperature collector 600 determines whether the second temperature T2 exceeds the third temperature T3. Upon determining that the second temperature T2 exceeds the third temperature T3, operation S630 is executed. Upon determining that the second temperature T2 is equal to lower than the third temperature T3, the temperature collector 600 determines this situation as an error and adds +1 to the error count.

At operation S630, the temperature collector 600 determines whether respective temperature T4, T5, T6 and T7 measured by the first group of the temperature sensors 210a, 210b, 210c and 210d are similar to one another or are within a predetermined range. The temperature collector 600 executes operation S640 upon determining that the temperatures T4, T5, T6 and T7 are similar to one another and adds +1 to the error count upon determining that the temperatures T4, T5, T6 and T7 are not similar at operation S660.

At operation S640, the temperature collector 600 determines whether any one of the temperatures T4, T5, T6 and T7 measured by the first group of the temperature sensors 210a, 210b, 210c and 210d, for example, the temperature T4, exceeds the second temperature T2. Upon determining that the temperature T4 exceeds the second temperature T2, the temperature collector 600 initializes the error count at operation S650 and terminates the temperature measurement at operation S690.

At operation 670, the temperature collector 600 determines whether the error count is greater than a predetermined number q whenever the error count is calculated. Upon determining that the error count is equal to or less than the predetermined number q, the temperature measurement process is returned to operation S600 to re-measure temperatures. On the contrary, upon determining that the error count is greater than the predetermined number q, i.e., when measurement of values different from an expected value is repeated, the temperature collector 600 determines that there is an error in the temperature sensors 200. In one example of implementation, the temperature collector 600 may output a warning message. In this case, for example, the temperature collector 600 may output a message indicating wrong temperature measurement. After outputting the message, the temperature measurement is terminated at operation S690.

According to the present disclosure, a man-hour required to additionally install sensors configured to measure the temperature of the exhaust system may be reduced, and efficiency may be improved.

According to the present disclosure, deformation and destruction of exhaust system components due to perforation and welding may be prevented, and reliability may be improved.

According to the present disclosure, reliability in accuracy in the temperature of the exhaust system measured based on the temperatures of the fluid measured at multiple points may be ensured.

As is apparent from the above description, the present disclosure provides a temperature measurement apparatus for fluids which may accurately and effectively measure the temperature of exhaust gas.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

1. A temperature measurement apparatus for fluids, comprising:
a base, wherein a fluid flowing in a flow direction passes through the base; and
a plurality of temperature sensors disposed on or around the base, the plurality of temperature sensors being configured to measure a plurality of temperatures of the fluid.

2. The temperature measurement apparatus of claim 1, further comprising a temperature collector configured to collect and process the plurality of temperatures of the fluid measured by the plurality of temperature sensors.

3. The temperature measurement apparatus of claim 2, further comprising a wire configured to connect the plurality of temperature sensors to the temperature collector.

4. The temperature measurement apparatus of claim 1, wherein the base is a gasket disposed between parts connected to each other, wherein the fluid flows through the parts.

5. The temperature measurement apparatus of claim 4, wherein the fluid is exhaust gas flowing along exhaust system components of a vehicle, and wherein the base is a gasket configured to airtightly connect the exhaust system components to each other.

6. The temperature measurement apparatus of claim 1, further comprising a support rod fixed in the base, and wherein the plurality of temperature sensors are mounted to the support rod.

7. The temperature measurement apparatus of claim 6, further comprising one or more reinforcement members configured to reinforce fixation of the support rod to the base.

8. The temperature measurement apparatus of claim 1, further comprising an extension rod connected to the base and configured to extend parallel to the flow direction,
wherein the plurality of temperature sensors are mounted on the extension rod.

9. The temperature measurement apparatus of claim 8, wherein the extension rod is formed of a soft material.

10. The temperature measurement apparatus of claim 1, further comprising a support rod fixed in the base and configured to extend through a center of the base,
wherein at least one of the plurality of the temperature sensors is mounted on the support rod.

11. The temperature measurement apparatus of claim 1, further comprising a hole formed through the base and configured such that the fluid passes through the hole,
wherein the plurality of the temperature sensors comprises a group of temperature sensors disposed around the hole.

12. The temperature measurement apparatus of claim 1, further comprising a hole formed through the base and configured such that the fluid passes through the hole,
wherein the plurality of the temperature sensors comprises a group of temperature sensors connected to the base and disposed to be spaced apart from the base.

13. The temperature measurement apparatus of claim 1, further comprising a hole formed through the base and configured such that the fluid passes through the hole,
wherein the plurality of the temperature sensors comprises a group temperature sensor connected to the base and disposed in a center of the hole.

14. A temperature measurement method for moving fluids by a temperature measurement apparatus comprising a base, a plurality of temperature sensors, and a temperature collector configured to collect and process a plurality of temperatures measured by the plurality of temperature sensors, the temperature measurement method comprising:
comparing a first temperature of a fluid measured at an upstream of the base and a second temperature of the fluid measured at a center of a fluid flow configured to pass through the base;
comparing the second temperature to a third temperature of the fluid measured at a downstream of the base;
comparing the second temperature to one or more fourth temperatures of the fluid measured at a plurality of points in a perimeter of the fluid flow configured to pass through the base; and
determining whether values of the first temperature, the second temperature, the third temperature, and the one or more fourth temperatures follow a predetermined order based on the comparisons.

15. The temperature measurement method according to claim 14, further comprising:
determining whether the one or more fourth temperatures measured at the plurality of points is within a designated error range with respect to one another; and
comparing the second temperature with the one or more fourth temperatures, upon determining that the one or more fourth temperatures are within the designated error range.

16. The temperature measurement method according to claim 14, further comprising determining that a first error occurs when the first temperature is equal to or lower than the second temperature.

17. The temperature measurement method according to claim 16, further comprising determining that a second error occurs when the second temperature is equal to or lower than the third temperature.

18. The temperature measurement method according to claim 17, further comprising determining that a third error occurs when the one or more fourth temperatures are equal to or lower than the second temperature.

19. The temperature measurement method according to claim 18, further comprising outputting a message indicating a measurement error when a sum total of numbers of times of occurrence of the first, second, and third errors exceeds a designated number of times.
